(19) United States
(12) Patent Application Publication
(10) Pub. No.: US 2018/0221749 A1
(43) Pub. Date: Aug. 9, 2018

(54) TEAM FORMATION SYSTEM

(71) Applicant: Aaron K. Le, Stanton, CA (US)

(72) Inventor: Aaron K. Le, Stanton, CA (US)

(21) Appl. No.: 15/889,105

(22) Filed: Feb. 5, 2018

Related U.S. Application Data
(60) Provisional application No. 62/454,566, filed on Feb. 3, 2017.

(51) Int. Cl. A63B 71/06

(52) U.S. Cl. CPC A63B 71/0616; G06Q 50/01

(57) ABSTRACT

A method and apparatus can include: creating a team profile; creating a member profile; storing the member profile; searching the member table; displaying a potential member; detecting the selection of the potential member as a selected member; displaying the selected member; detecting the selection of the recruit member option; sending a member recruit request; detecting a member recruit response; displaying the member recruit response; searching the team table; displaying a potential team; detecting a team selection; displaying the selected team; detecting the selection of the join team option.

### CROSS-REFERENCE TO RELATED APPLICATIONS

This claims priority benefit to all common subject matter of U.S. Provisional Patent Application 62/454,566 filed Feb. 3, 2017. The content of this applications is incorporated herein by reference.

### TECHNICAL FIELD

This disclosure relates to social network technology, more particularly to systems and methods for improving social network technology for the formation of teams.

### BACKGROUND

Conventionally, people who want to build a team would have to directly communicate their interests to individuals of whom they know personally. For example, a person who wants to build a basketball team to play for a recreational league would have to search within their network and go through the process of asking people directly if they are interested in basketball, whether or not they are already in a basketball team, and whether or not they want to be part of their team.

This conventional process of finding people to be part of a team can be very time consuming, and often limited if the individual has a small network or has a network that's saturated with people who already belong in other teams.

In recent years the rise of computational systems for organizing teams and players has led to a greater effectiveness and efficiency in terms of time and decision making. The organization of sports teams and players has become a sophisticated and involved activity, not only for professional sports teams, but also for recreational sports teams.

Numerical and biographical data are often used to rate or profile players, and large numbers of graphs or drawings are involved in the generation and explanation of drills, plays, teams, and organizational components of teams. The application of computers to process data relating to the players is becoming more prevalent.

The information processing capabilities of computer based team organizers allow a team manager or coach to rapidly access the team's roster information, individual player capabilities, and game histories, such as wins, losses, and scores. Team lineups may be generated based on the individual player's abilities to enhance the overall performance of the team.

However, even with the greatly increased use of computational technology in the team organizational process, the team formation process relies almost entirely on the manual actions, subjective decisions, and personal knowledge of team organizers rather than information, processes, and decision possibilities by way of purposefully designed team formation systems and networked communications. As such team formation remains a slow and tedious process with a large felt need for improvement and a desperate search for more sophisticated technological based approaches to team formation.

Solutions have been long sought but prior developments have not taught or suggested any complete solutions, and solutions to these problems have long eluded those skilled in the art. Thus, there remains a considerable need for devices and methods that can provide a technology based solution enabling networked communication and effective data usage in the formation of teams.

### SUMMARY

A team formation system and methods, providing a technology based solution enabling networked communication and effective data usage in the formation of teams, are disclosed. The team formation system and methods can include: creating a team profile including team profile information; storing the team profile information on a team table in a database; creating a member profile, the member profile including personal information and athletic information; storing the member profile on a member table in the database; searching the member table based on member search criteria; displaying a potential member based on the potential member having the member profile matching the member search criteria, and displaying the potential member includes displaying a member location, a member name, a member age, a member height, a member identification number, and a member image; detecting the selection of the potential member as a selected member; displaying the selected member including the member location, the member name, a member statement, the member image, a member teams tab, a member schedule tab, and a recruit member option; detecting the selection of the recruit member option as a member recruit request; sending the member recruit request to the selected member; detecting a member recruit response; displaying the member recruit response; searching the team table based on team search criteria; displaying a potential team based on the potential team having the team profile information matching the team search criteria, and displaying the potential team includes displaying a team location, a team name, a sport type, a team identification number, a number of team members, a team description, and a team image; detecting a team selection of the potential team as a selected team; displaying the selected team including the team location, the team name, the sport type, the team description, the team image, a team roster, a team schedule, and a join team option; detecting the selection of the join team option as a join team request by a member; sending the join team request to a team captain; detecting a join team response; and displaying the join team response.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The team formation system is illustrated in the figures of the accompanying drawings which are meant to be exemplary and not limiting, in which like reference numerals are intended to refer to like components, and in which:

FIG. 1 is an exemplary distributed computer system according to an embodiment of the team formation system.

FIG. 2 is a graphical depiction of the team formation system in a display team tools step.

FIG. 3 is a graphical depiction of the team formation system in a display member profile step.

FIG. 4 is a graphical depiction of the team formation system in a display team profile step.

FIG. 5 is a graphical depiction of the team formation system in a display join teams overview step.

FIG. 6 is a graphical depiction of the team formation system in a display join teams select team type step.

FIG. 7 is a graphical depiction of the team formation system in a display join teams select sport type step.

FIG. 8 is a graphical depiction of the team formation system in a display join teams select team level step.

FIG. 9 is a graphical depiction of the team formation system in a display join teams select team location step.

FIG. 10 is a graphical depiction of the team formation system in a display join teams potential teams list step.

FIG. 11 is a graphical depiction of the team formation system in a display join teams selected team step.

FIG. 12 is a graphical depiction of the team formation system in a display join teams send selected team confirmation step.

FIG. 13 is a graphical depiction of the team formation system in a display join teams selected team confirmation step.

FIG. 14 is a graphical depiction of the team formation system in a display create teams overview step.

FIG. 15 is a graphical depiction of the team formation system in a display create teams select team type step.

FIG. 16 is a graphical depiction of the team formation system in a display create teams select sport type step.

FIG. 17 is a graphical depiction of the team formation system in a display create teams select team level step.

FIG. 18 is a graphical depiction of the team formation system in a display create teams select team location step.

FIG. 19 is a graphical depiction of the team formation system in a display create teams team confirmation step.

FIG. 20 is a graphical depiction of the team formation system in a display my teams step.

FIG. 21 is a graphical depiction of the team formation system in a display recruiting members overview step.

FIG. 22 is a graphical depiction of the team formation system in a display recruiting members select team step.

FIG. 23 is a graphical depiction of the team formation system in a display recruiting members select member age requirement step.

FIG. 24 is a graphical depiction of the team formation system in a display recruiting members select member height requirement step.

FIG. 25 is a graphical depiction of the team formation system in a display recruiting members select member location step.

FIG. 26 is a graphical depiction of the team formation system in a display recruiting members potential member selection list step.

FIG. 27 is a graphical depiction of the team formation system in a display recruiting members selected member step.

FIG. 28 is a graphical depiction of the team formation system in a display recruiting members selected member request confirmation step.

FIG. 29 is a graphical depiction of the team formation system in a display recruiting members selected member response step.

FIG. 30 is a control flow for the team formation system.

### DETAILED DESCRIPTION

In the following description, reference is made to the accompanying drawings that form a part hereof, and in which are shown by way of illustration, embodiments in which the team formation system may be practiced. It is to be understood that other embodiments may be utilized and structural changes may be made without departing from the scope of the team formation system.

When features, aspects, or embodiments of the product development system are described in terms of steps of a process, an operation, a control flow, or a flow chart, it is to be understood that the steps would be recognized as algorithmic steps, can be combined, performed in a different order, deleted, or include additional steps without departing from the product development system as described herein.

The team formation system is described in sufficient detail to enable those skilled in the art to make and use the team formation system and provide numerous specific details to give a thorough understanding of the team formation system; however, it will be apparent that the team formation system may be practiced without these specific details.

In order to avoid obscuring the team formation system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGs. Generally, the team formation system can be operated in any orientation.

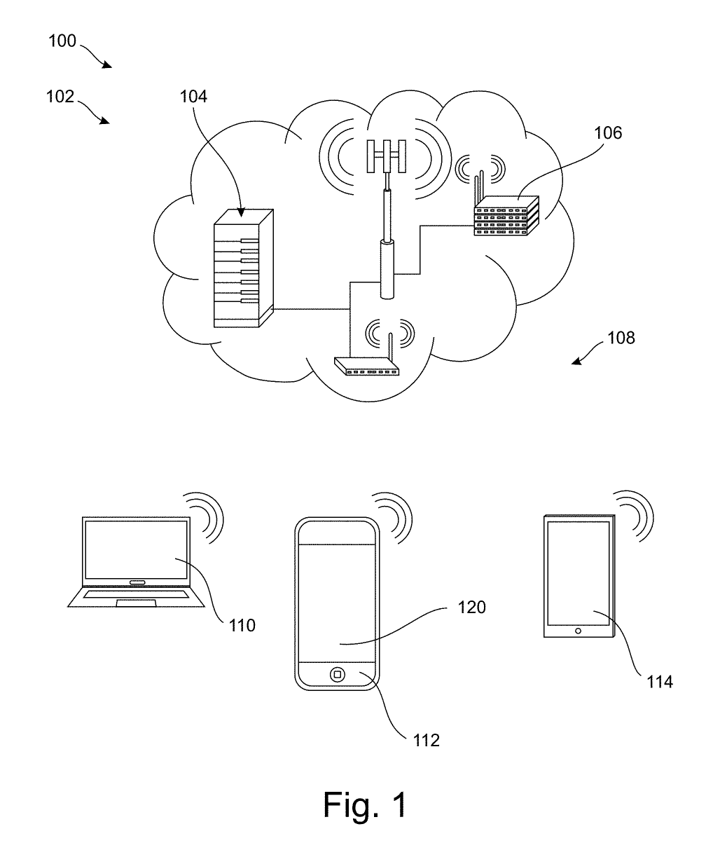

Referring now to FIG. 1, therein is shown an exemplary distributed computer system according to an embodiment of the team formation system 100. The team formation system 100 can include elements of a distributed computing system 102 including servers 104, routers 106, and other telecommunications infrastructure.

The distributed computing system 102 can include the Internet, a wide area network, (WAN), a metropolitan area network (MAN), a local area network (LAN), a telephone network, cellular data network (e.g., 3G, 4G) and/or a combination of these and other networks (wired, wireless, public, private or otherwise).

The servers 104 can function both to process and store data for use on user devices 108 including laptops 110, cellular phones 112, and tablet computers 114. It is contemplated that the servers 104 and the user devices 108 can individually comprise a central processing unit, memory, storage and input/output units and other constituent components configured to execute applications including software suitable for displaying user interfaces, the interfaces optionally being generated by a remote server, interfacing with the cloud network, and managing or performing capture, transmission, storage, analysis, display, or other processing of data and or images.

For the purposes of this application it is to be understood that when operations are described in terms of process steps, including retrieving steps, storing steps, displaying steps, detecting steps, calculating steps, and determining steps, the steps are performed by the central processing unit of either the servers 104, the user devices 108, or a combination thereof. Further, for the purposes of this application it is to be understood that when operations are described in terms of process steps, the steps can be executed by instructions configured to execute the step residing in non-transitory computer readable medium. Specifically for display steps, it is to be understood that the display steps are raw information stored in the user devices 108 or the servers 104 processed by the central processing units of the user devices 108 or the servers 104 and displayed on the user devices 108.

The servers 104 and the user devices 108 of the team formation system 100 can run applications based on Objective-C for iOS and Java for Android, and can further include a web browser operative for, by way of example, retrieving web pages or other markup language streams, presenting those pages or streams, executing scripts, controls and other code on those pages or streams, accepting user input with respect to those pages or streams, and issuing HTTP requests with respect to those pages or streams. The web pages or other markup language can be in HAML, CSS, HTML, Ruby on Rails or other conventional forms, including embedded XML, scripts, controls, and so forth as adapted in accord with the teachings hereof. The user devices 108 and the servers 104 can be used individually or in combination to store and process information from the team formation system 100 in the form of protocol, parameters, images, protocol instructions and protocol guides.

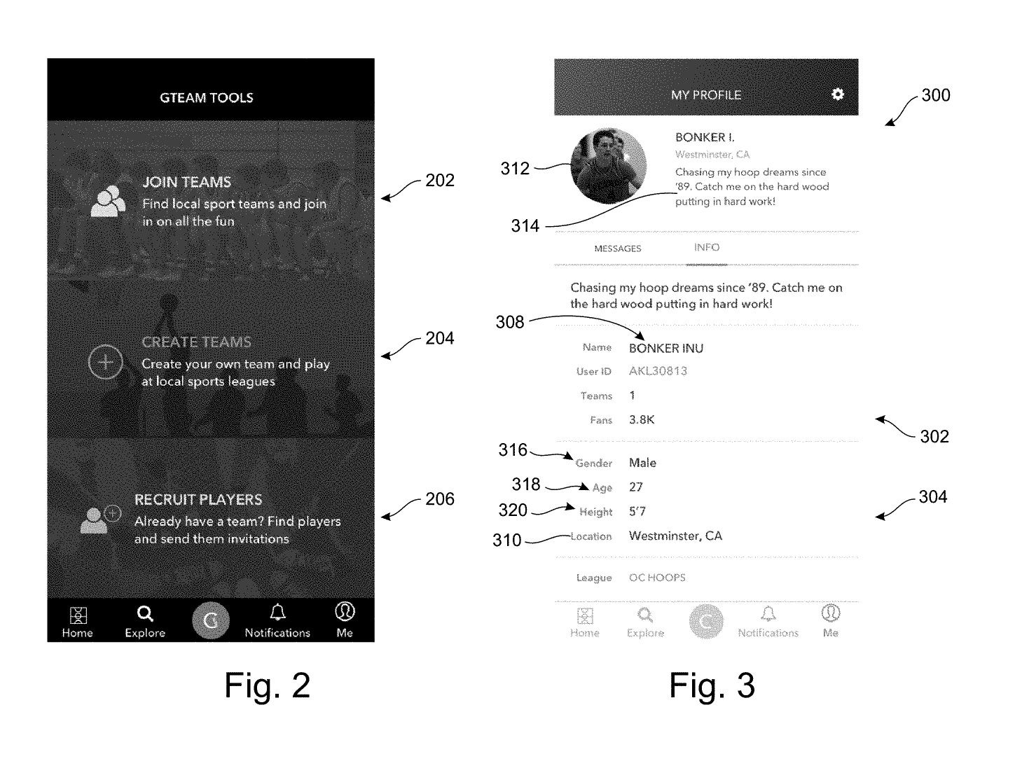

Referring now to FIG. 2, therein is shown a graphical depiction of the team formation system 100 of FIG. 1 in a display team tools step. The display team tools step can display a join team tool 202 which is described with regard to FIGS. 5-13 below.

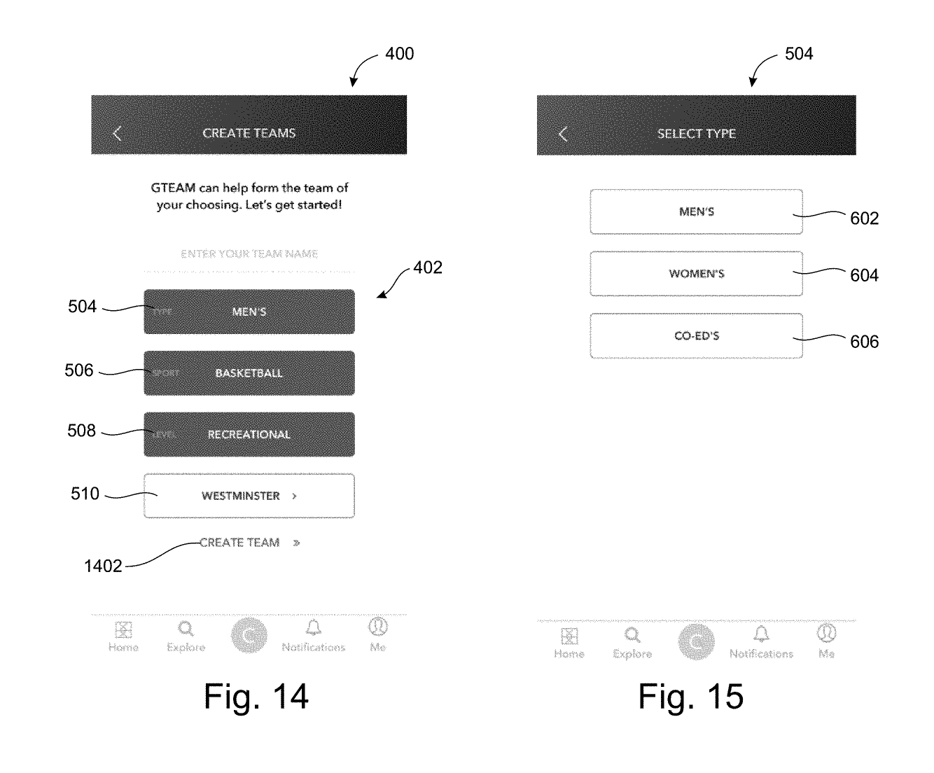

The display team tools step can further display a create team tool 204 which is described with regard to FIGS. 14-20 below. The display team tools step can further display a recruit member tool 206 which is described with regard to FIGS. 21-29 below.

Illustratively, it is contemplated that the join team tool can enable a member to find and join local sport teams. It is further contemplated that the create team profile tool 204 can enable a member to create their own sports team, which can participate in local sports leagues. It is yet further contemplated that the recruit member tool 206 can enable members to recruit members for a specific team.

Referring now to FIG. 3, therein is shown a graphical depiction of the team formation system 100 of FIG. 1 in a display member profile step. The display member profile step can display a member profile 300. The member profile 300 can include personal information 302 and athletic information 304.

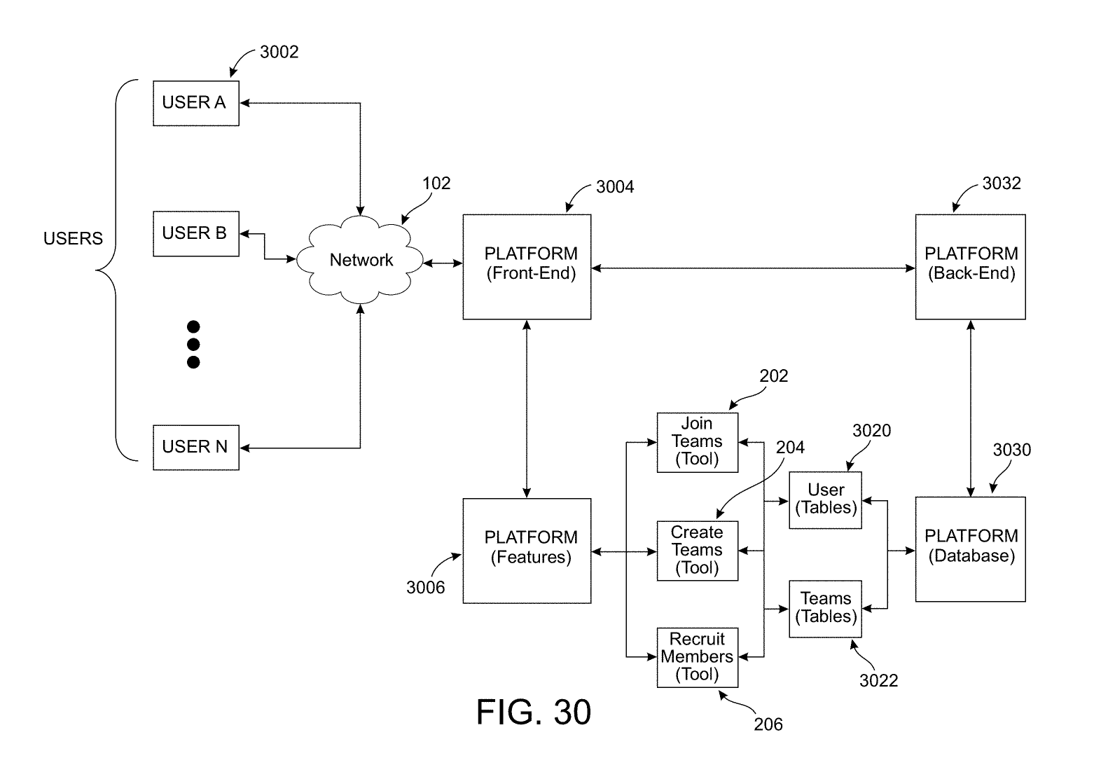

It is contemplated, for example, that the personal information 302 can include member name 308, member location 310, member image 312, and member statement 314 as a character string. It is further contemplated, for example, that the athletic information 304 can include strengths and attributes of the member including member gender 316, member age 318, member height 320, member positions played, member level of play, member statistics, and member achievements. It is contemplated that the member level of play can include a professional level, an academic level, and a recreational level of play. The member profile 300 for each member can be stored on the member table 3020 of FIG. 30 in the database 3030 of FIG. 30.

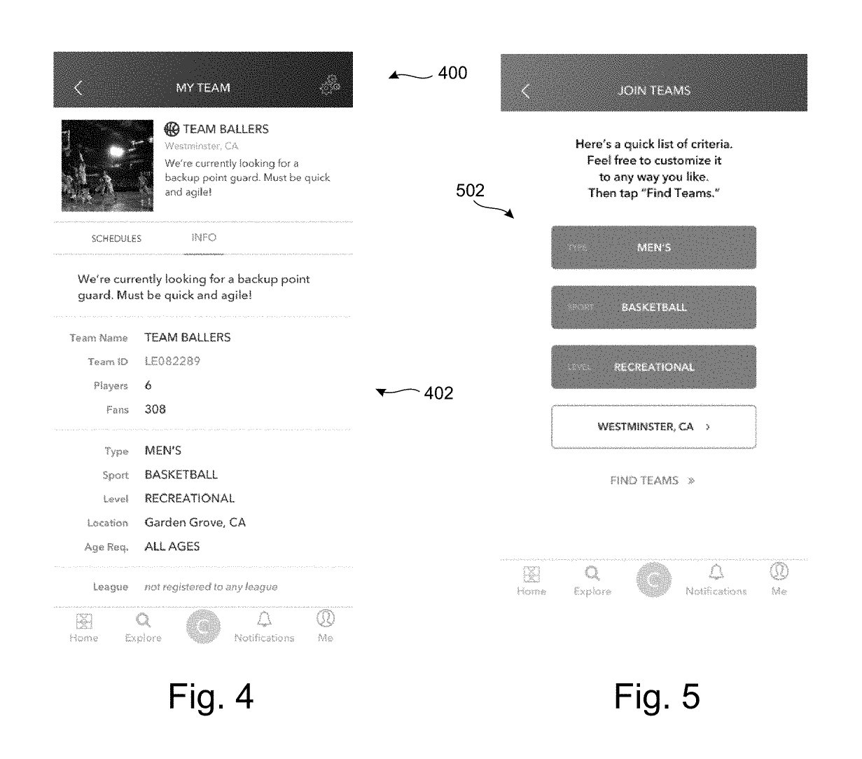

Referring now to FIG. 4, therein is shown a graphical depiction of the team formation system 100 of FIG. 1 in a display team profile step. The display team profile step can display a team profile 400. The team profile 400 can include team profile information 402 stored in the team table 3022 of FIG. 30 on the database 3030 of FIG. 30.

Referring now to FIG. 5, therein is shown a graphical depiction of the team formation system 100 of FIG. 1 in a display join teams overview step. The display join teams overview step can display team filters 502 for filtering the teams of the team table 3022 of FIG. 30 based on the team profile information 402 of FIG. 4.

Illustratively, the team filters 502 can include filters for the team profile information 402 of FIG. 4 including a team type 504, sport type 506, team level 508, and team location 510. The team filters 502 can allow members to search the team table 3022 based on team search criteria. The team search criteria can be the team filters 502 selected by a member.

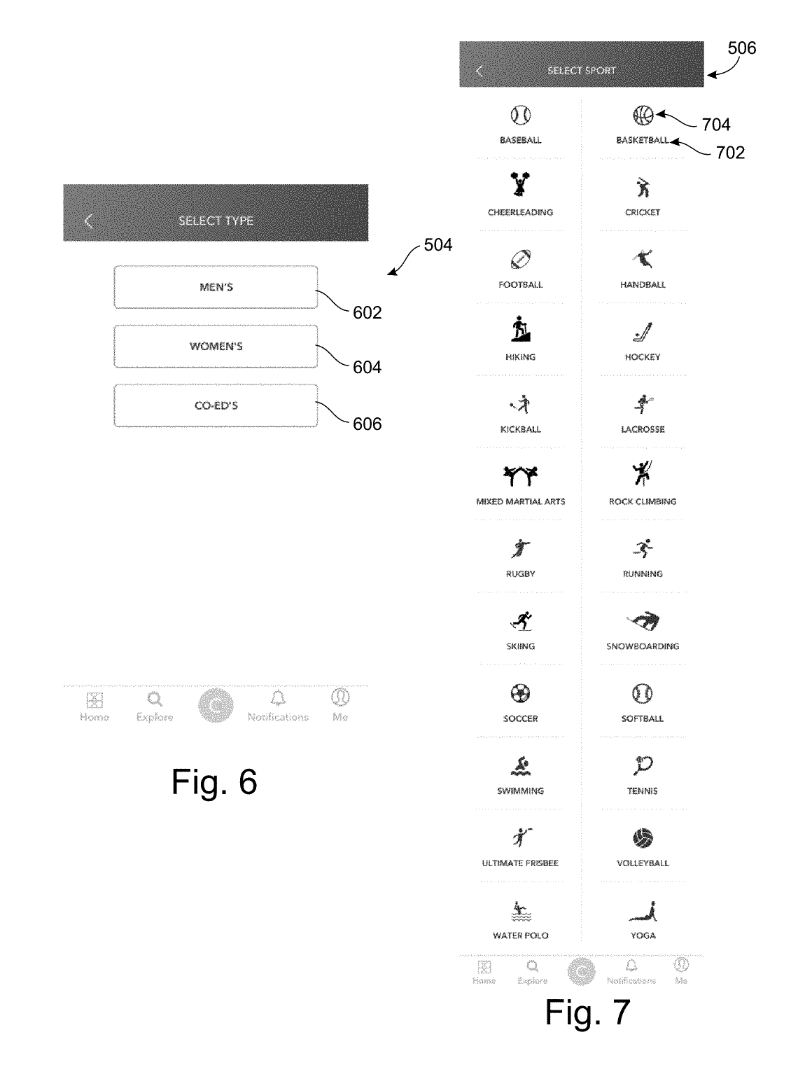

Referring now to FIG. 6, therein is shown a graphical depiction of the team formation system 100 of FIG. 1 in a display join teams select team type step. The display join teams select team type step can allow the member to apply the team filters 502 of FIG. 5 for searching the team table 3022 of FIG. 30 based on the team type 504 team type. The team type 504 including men's 602, women's 604, and co-ed's 606. The team type 504 can be selected by the member and the member's selection can be detected by the team formation system 100.

Referring now to FIG. 7, therein is shown a graphical depiction of the team formation system 100 of FIG. 1 in a display join teams select sport type step. The display join teams select sport type step can allow the member to apply the team filters 502 of FIG. 5 for searching the team table 3022 of FIG. 30 based on the sport type 506. The sport type 506 can include a list of sport types including icons 702 and descriptors 704. The sport type 506 can be selected by the member and the member's selection can be detected by the team formation system 100.

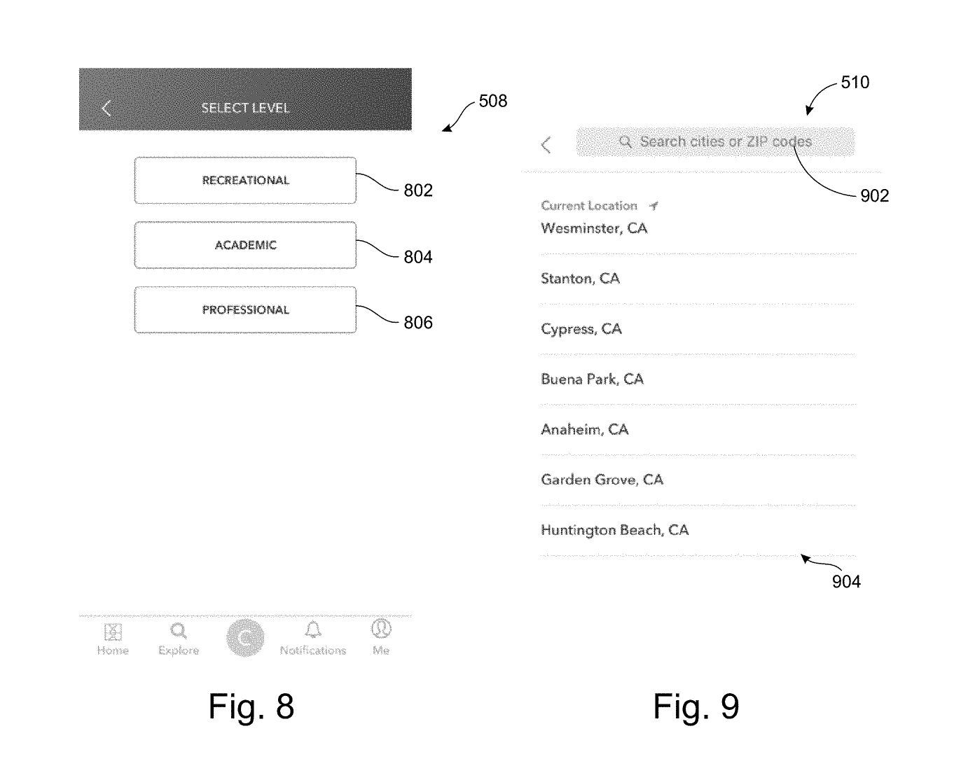

Referring now to FIG. 8, therein is shown a graphical depiction of the team formation system 100 of FIG. 1 in a display join teams select team level step. The display join teams select team level step can allow the member to apply the team filters 502 of FIG. 5 for searching the team table 3022 of FIG. 30 based on the team level 508. The team level 508 can be the play level of the team and can include recreational 802, academic 804, and professional 806. The team level 508 can be selected by the member and the member's selection can be detected by the team formation system 100.

Referring now to FIG. 9, therein is shown a graphical depiction of the team formation system 100 of FIG. 1 in a display join teams select team location step. The display join teams select team location step can allow the member to apply the team filters 502 of FIG. 5 for searching the team table 3022 of FIG. 30 based on the team location 510. Illustratively, searching the team table 3022 based on the team location 510 is shown to include displaying a search bar 902 for entering a city or ZIP code, and further displaying a list of possible current locations 904 of the member. The team location 510 can be selected by the member and the member's selection can be detected by the team formation system 100.

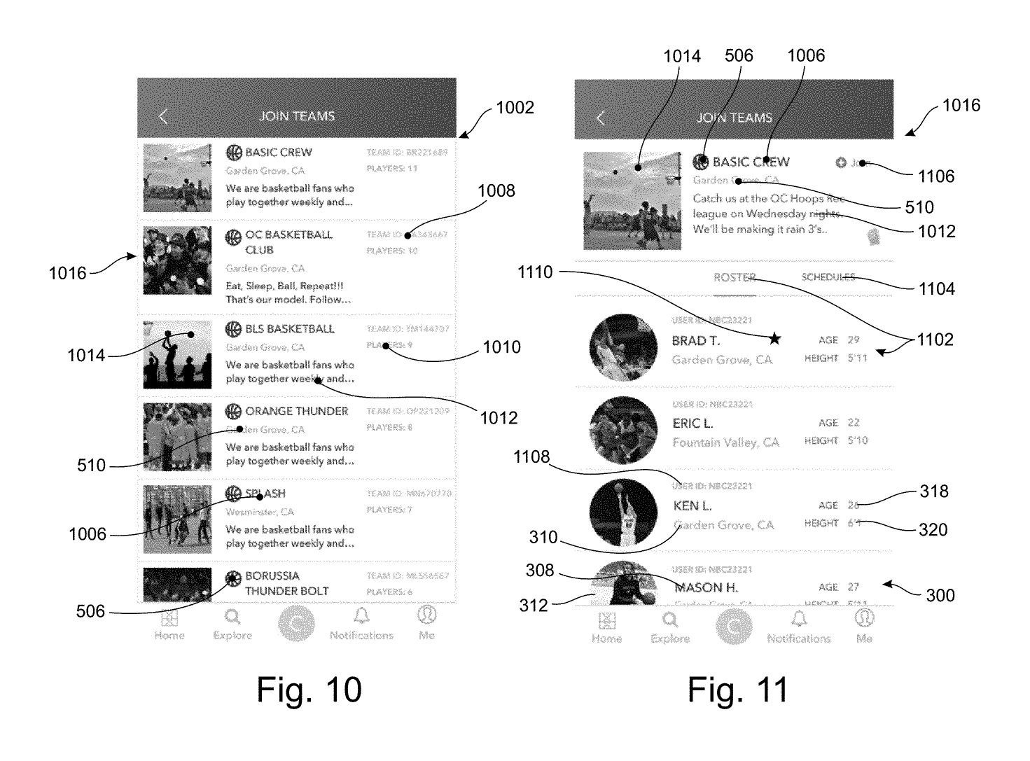

Referring now to FIG. 10, therein is shown a graphical depiction of the team formation system 100 of FIG. 1 in a display join teams potential teams list step. The display join teams potential teams list step can display results of a search based on the team filters 502 of FIG. 5 as applied to the team table 3022 of FIG. 30. The results of the search can be potential teams 1002 which the member may choose to select and request to join.

The potential teams 1002 can be displayed based on the potential team 1002 having the team profile information 402 of FIG. 4 matching the team search criteria implemented by a member through the selection of the team filters 502. The potential teams 1002 can be displayed in a list with each having the team location 510, a team name 1006, the sport type 506, a team identification number 1008, a number of team members 1010, a team description 1012, and a team image 1014.

As will be appreciated, the sport type 506 displayed for the potential teams 1002 can be the icon 702 of FIG. 7. That is, the sport type 506 displayed with the icon 702 can match the previously displayed sport type 506 during the display join teams select sport type step. One of the potential teams 1002 can be selected by the member and the member's selection can be detected by the team formation system 100 as a selected team 1016.

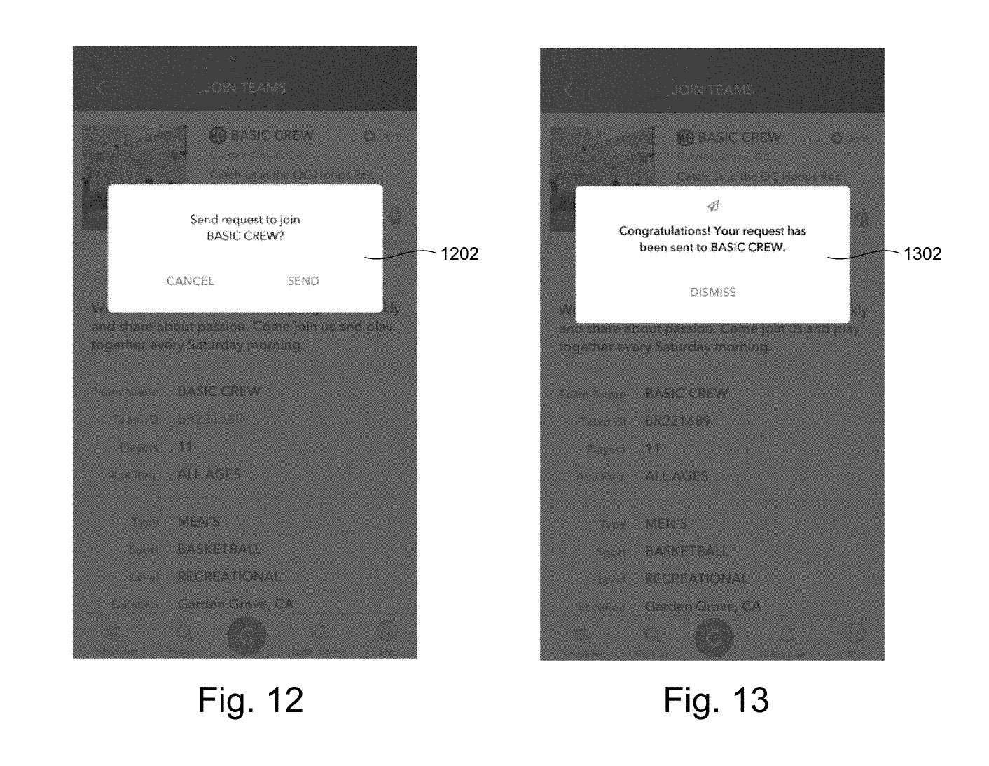

Referring now to FIG. 11, therein is shown a graphical depiction of the team formation system 100 of FIG. 1 in a display join teams selected team step. The display join teams selected team step can display the selected team 1016 selected by the member during the display join teams potential teams list step of FIG. 12.

Displaying the selected team 1016 can include displaying the team location 510, the team name 1006, the sport type 506, the team description 1012, the team image 1014, a team roster 1102, a team schedule 1104, and a join team option 1106.

As is illustratively depicted the team roster 1102 of the selected team 1016 can be displayed including the member profiles 300 for the team members of the selected team 1016. The member profiles 300 for the team members of the selected team 1016 can include the member name 308, the member age 318, the member height 320, the member location 310, the member image 312, a member identification number 1108 and a team captain icon 1110.

The team schedule 1104 of the selected team 1016 can be displayed including the time, location, and opposing team for a future game. The team formation system 100 can detect the selection of the join team option 1106 as a join team request by a member.

Referring now to FIG. 12, therein is shown a graphical depiction of the team formation system 100 of FIG. 1 in a display join teams send selected team confirmation step. The display join teams send selected team confirmation step can be executed once the member selects the join team option 1106 of FIG. 11 for the selected team 1016 of FIG. 10. The display join teams send selected team confirmation step can ensure the member wishes to send the join team request to the selected team 1016 team captain by displaying a confirmation request 1202.

Once confirmed, the team formation system 100 can send the join team request to the team captain of the selected team 1016, the join team request including the member profile 300 of FIG. 3 with the personal information 302 of FIG. 3 of the requesting member and the athletic information 304 of FIG. 3 of the requesting member.

Referring now to FIG. 13, therein is shown a graphical depiction of the team formation system 100 of FIG. 1 in a display join teams selected team confirmation step. It is contemplated that once the join team request is sent to the team captain of the selected team 1016 of FIG. 10, the team captain of the selected team 1016 can select to accept or deny the member's join team request.

The team formation system 100 can detect the acceptance or denial of the join team request and can display, during the display join teams selected team confirmation step, a join team response 1302. The join team response 1302 can include a denial or an approval of the join team request.

Referring now to FIG. 14, therein is shown a graphical depiction of the team formation system 100 of FIG. 1 in a display create teams overview step. The display create teams overview step can display the team profile 400 which can be created with the team profile information 402. The team profile information 402 can be created for each team and stored on the team table 3022 of FIG. 30 within the database 3030 of FIG. 30.

Illustratively, the team profile information 402 can include the team type 504, the sport type 506, the team level 508, and the team location 510. It is contemplated that the team level 508 can be the play level of the team.

It is further contemplated that the team profile information 402 can include a required age for members of the team. The display create teams overview step is further depicted with a create team selection 1402.

Referring now to FIG. 15, therein is shown a graphical depiction of the team formation system 100 of FIG. 1 in a display create teams select team type step. The display create teams select team type step can allow the member to select the team type 504 as a men's 602, a women's 604, and a co-ed's 606. The team type 504 selection can be detected by the team formation system 100 and can be stored by the team formation system 100 as one part of the team profile information 402 of FIG. 4 within the team table 3022 of FIG. 30.

Referring now to FIG. 16, therein is shown a graphical depiction of the team formation system 100 of FIG. 1 in a display create teams select sport type step. The display create teams select sport type step can allow the member to select the sport type 506 including the icons 702 and the descriptors 704. The sport type 506 selection can be detected by the team formation system 100 and can be stored by the team formation system 100 as one part of the team profile information 402 of FIG. 4 within the team table 3022 of FIG. 30.

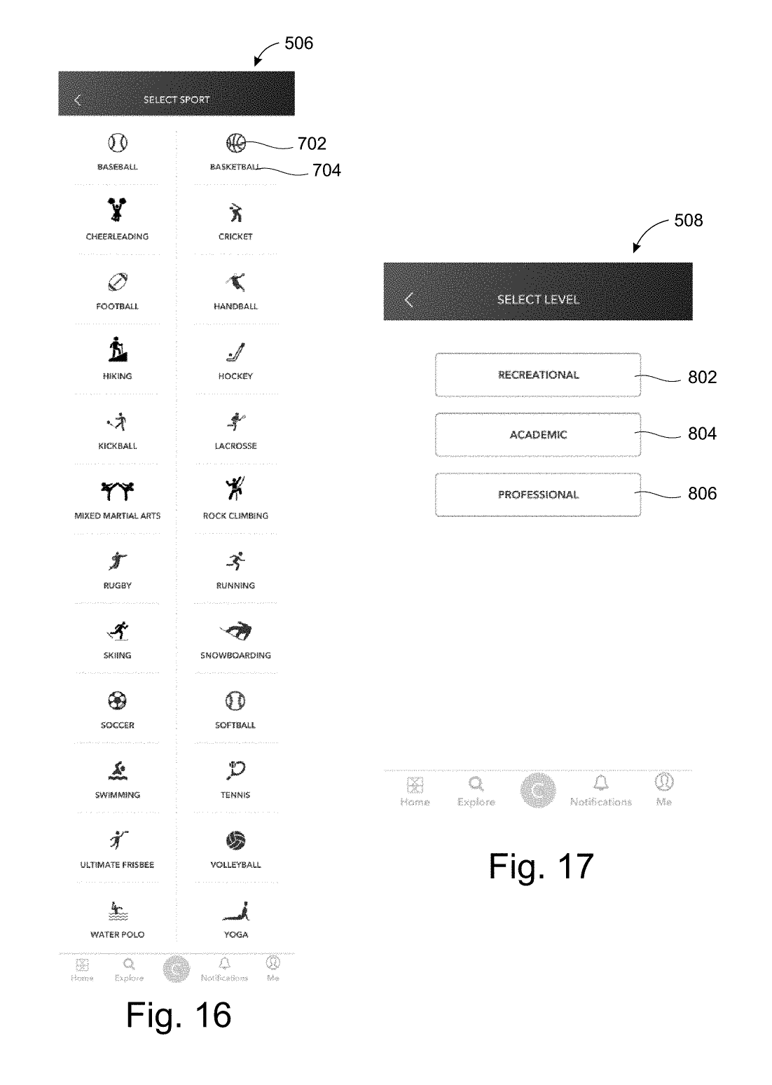

Referring now to FIG. 17, therein is shown a graphical depiction of the team formation system 100 of FIG. 1 in a display create teams select team level step. The display create teams select team level step can allow the member to select the team level 508 as the recreational level 802, the academic level 804, and the professional level 806. The team level 508 can be the play level of the team. The team level 508 selection can be detected by the team formation system 100 and can be stored by the team formation system 100 as one part of the team profile information 402 of FIG. 5 within the team table 3022 of FIG. 30.

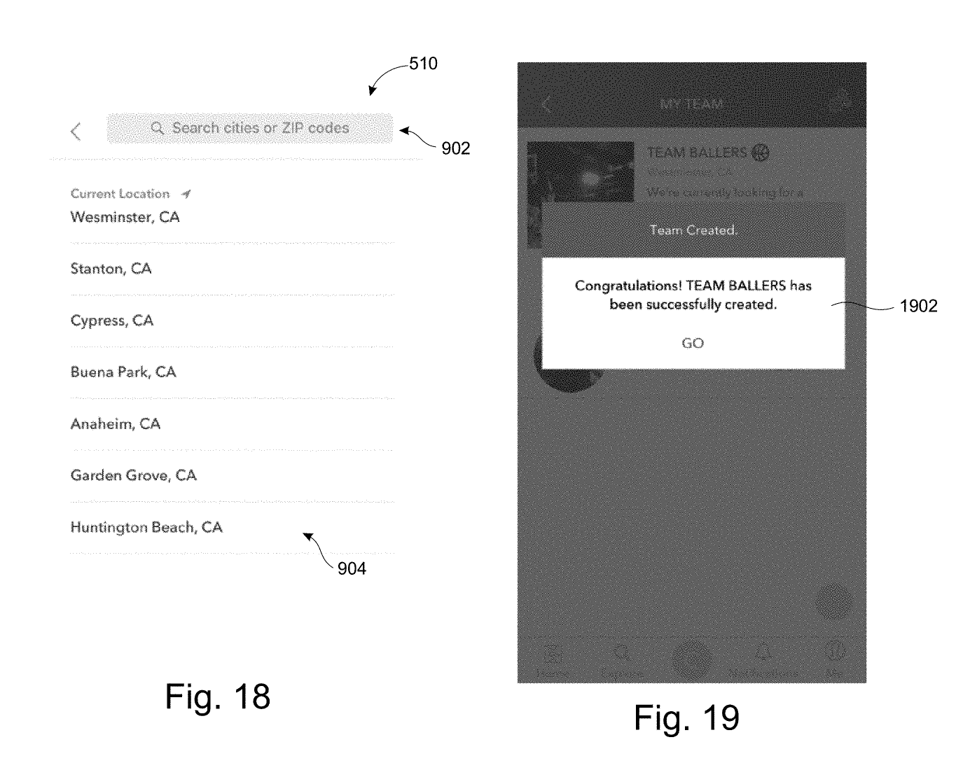

Referring now to FIG. 18, therein is shown a graphical depiction of the team formation system 100 of FIG. 1 in a display create teams select team location step. The create teams select team location step can allow the member to select the team location 510.

The create teams select team location step can require the member to identify and select a practice location, identify and select a home game location, and identify and select an away game location. The display create teams select team location step can display the search bar 902 for entering a city or ZIP code and can display a list of possible current locations 904 for the member creating the team. The team location 510 selection can be detected by the team formation system 100 and can be stored by the team formation system 100 as one part of the team profile information 402 of FIG. 4 within the team table 3022 of FIG. 30.

Referring now to FIG. 19, therein is shown a graphical depiction of the team formation system 100 of FIG. 1 in a display create teams team confirmation step. The display create teams team confirmation step can display a creation confirmation 1902 based on the team formation system 100 detecting the selection of the create team selection 1402 of FIG. 14. The display create teams team confirmation step can be displayed once the team profile 400 of FIG. 4 has been fully populated with the team profile information 402.

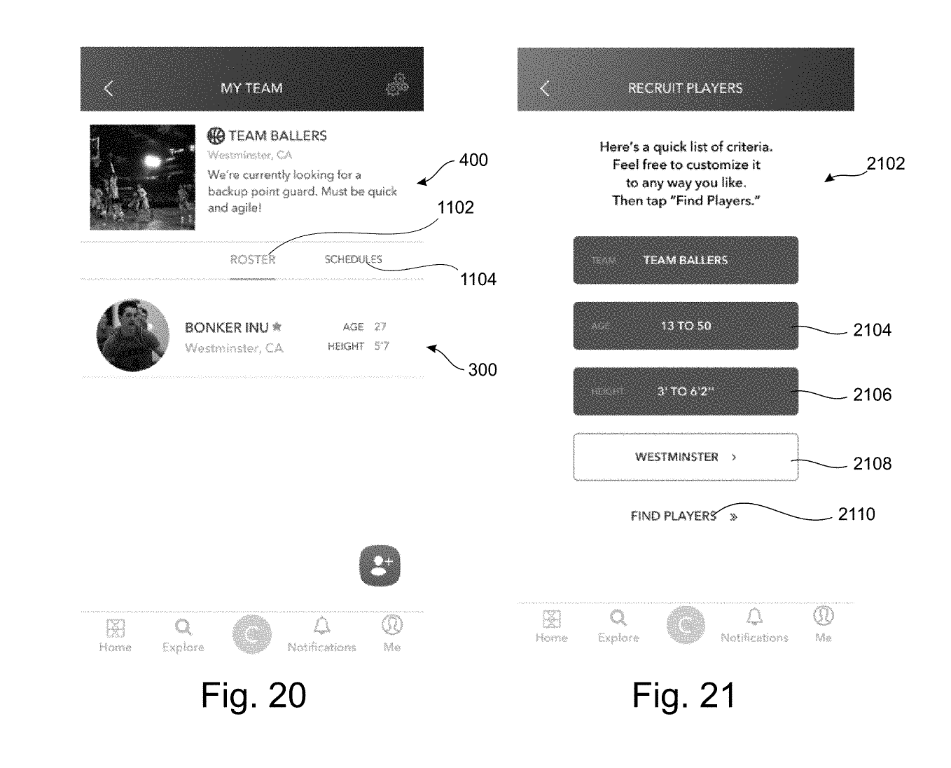

Referring now to FIG. 20, therein is shown a graphical depiction of the team formation system 100 of FIG. 1 in a display my teams step. The display my teams step can include the display of the member profile 300 and the team profile 400 based on the member creating the team. It will be appreciated that the member creating the team is automatically included on the team roster 1102.

The display my teams step can display both the team roster 1102 and the team schedule 1104. The display my teams step can further display an icon for adding additional team members.

Referring now to FIG. 21, therein is shown a graphical depiction of the team formation system 100 of FIG. 1 in a display recruiting members overview step. The display recruiting members overview step can display member filters 2102 for filtering the members of the member table 3020 of FIG. 30 on the database 3030 of FIG. 30 based on the personal information 302 of FIG. 3 and the athletic information 304 of FIG. 3 of the member profile 300 of FIG. 3.

The member filters 2102 can be search criteria for the members of the member table 3020. It is contemplated that the member filters 2102 can include the member age 318 of FIG. 3 displayed as an age range 2104, the member height 320 of FIG. 3 displayed as a height range 2106, and the member location 310 of FIG. 3.

The display recruiting members overview step can further display a recruiting team 2108 that is recruiting the member and a find player option 2110. The find player option can execute the query of the database 3030 based on the member filters 2102.

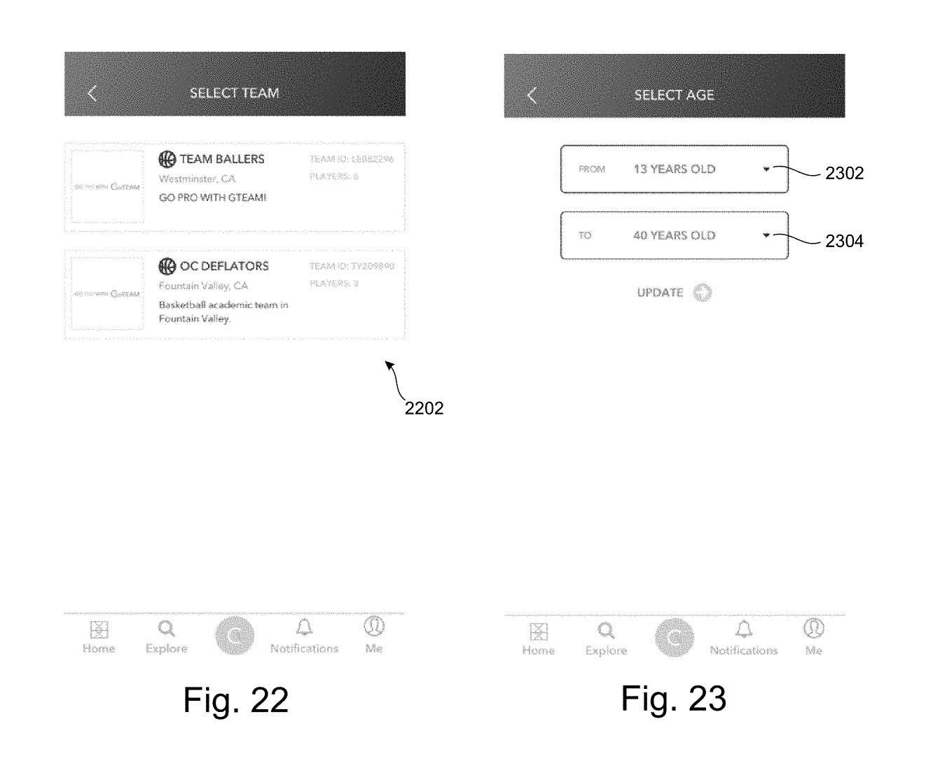

Referring now to FIG. 22, therein is shown a graphical depiction of the team formation system 100 of FIG. 1 in a display recruiting members select team step. The display recruiting members select team step can allow a member to select the recruiting team 2108 of FIG. 21 by displaying all the teams associated with the recruiting member as a list of associated teams 2202. A selection of one of the teams in the list of associated teams 2202 can be detected by the team formation system 100.

Referring now to FIG. 23, therein is shown a graphical depiction of the team formation system 100 of FIG. 1 in a display recruiting members select member age requirement step. The display recruiting members select member age requirement step can allow the member to apply the member filters 2102 of FIG. 21 for searching the member table 3020 of FIG. 30 based on the age range 2104 of FIG. 21. The display recruiting members select member age requirement step can display a selection for a youngest age 2302 and an oldest age 2304. The youngest age 2302 and the oldest age 2304 can be selected by the member and the member's selection can be detected by the team formation system 100 as one of the member filters 2102.

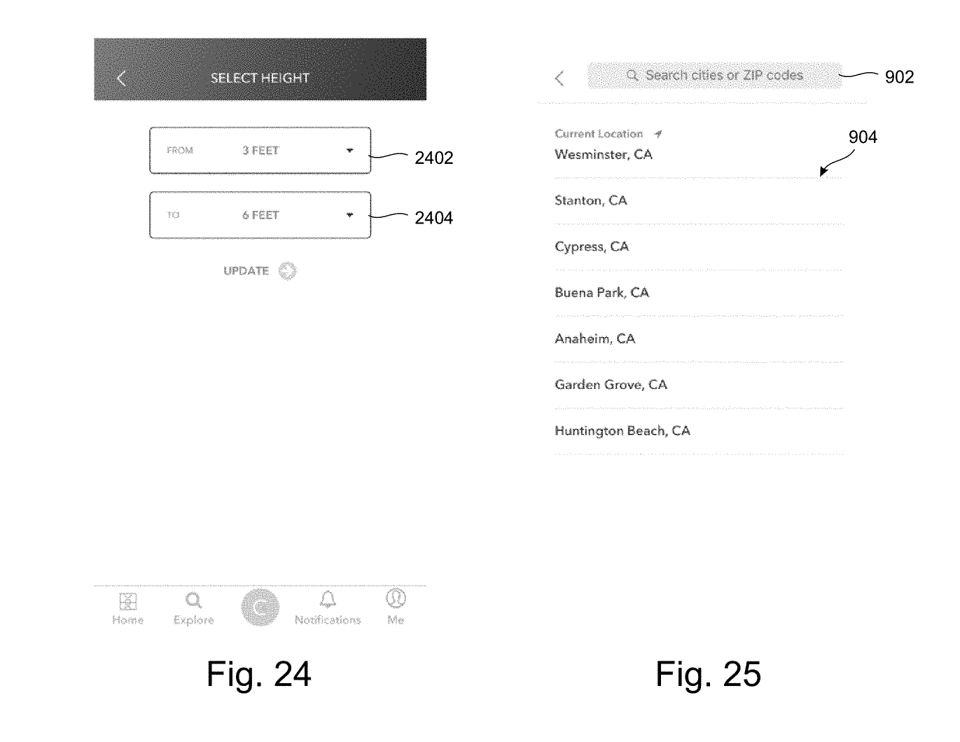

Referring now to FIG. 24, therein is shown a graphical depiction of the team formation system 100 of FIG. 1 in a display recruiting members select member height requirement step. The display recruiting members select member height requirement step can allow the member to apply the member filters 2102 of FIG. 21 for searching the member table 3020 of FIG. 30 based on the height range 2106 of FIG. 21. The display recruiting members select member height requirement step can display a selection for a shortest height 2402 and a tallest height 2404. The shortest height 2402 and the tallest height 2404 can be selected by the member and the member's selection can be detected by the team formation system 100 as one of the member filters 2102.

Referring now to FIG. 25, therein is shown a graphical depiction of the team formation system 100 of FIG. 1 in a display recruiting members select member location step. The display recruiting members select member location step can allow the member to apply the member filters 2102 of FIG. 21 for searching the member table 3020 of FIG. 30 based on the member location 310 of FIG. 3. The display recruiting members select member location step can display the search bar 902 for entering a city or ZIP code and can display a list of possible current locations 904. The member location 310 can be selected by the member and the member's selection can be detected by the team formation system 100 as one of the member filters 2102.

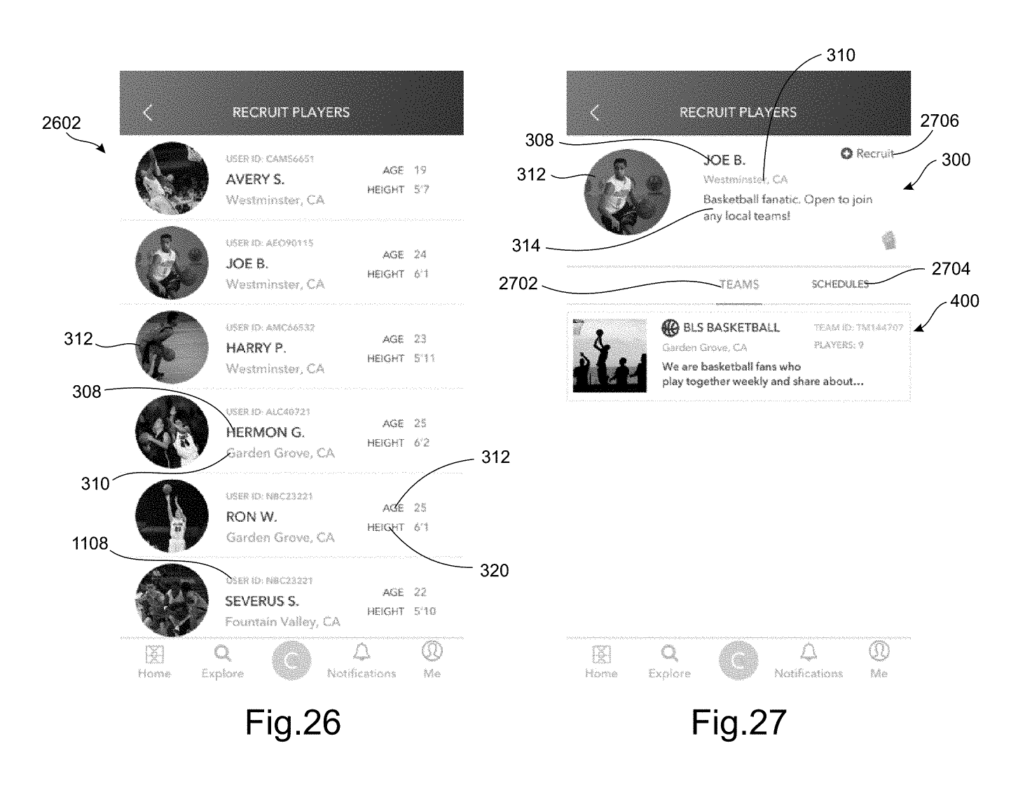

Referring now to FIG. 26, therein is shown a graphical depiction of the team formation system 100 of FIG. 1 in a display recruiting members potential member selection list step. The display recruiting members potential member selection list step can display results of a search based on the member filters 2102 of FIG. 21 as applied to the member table 3020 of FIG. 30. The results of the search can be potential members 2602 which the recruiting member may choose to select and request to join the recruiting team.

The potential members 2602 can be displayed based on the potential member 2602 having the member profile 300 of FIG. 3 matching the member search criteria implemented by the recruiting member through the selection of the member filters 2102. The potential members 2602 can be displayed in a list with each having the member location 310, the member name 308, the member age 318, the member height 320, the member identification number 1108, and the member image 312. One of the potential members 2602 can be selected by the recruiting member and the member's selection can be detected by the team formation system 100 as a selected member 2604.

Referring now to FIG. 27, therein is shown a graphical depiction of the team formation system 100 of FIG. 1 in a display recruiting members selected member step. The display s recruiting members elected member step can include the display of the member profile 300 of the selected member 2604 of FIG. 26 and a teams tab 2702 displaying the team profiles 400 of any teams the selected member 2604 is a part of.

The display recruiting members selected member step also displays a schedule tab 2704 for displaying a schedule of the selected member 2604 along with a recruit member option 2708. The member profile 300 of the selected member 2604 can be displayed including the member location 310, the member name 308, the member statement 314, and the member image 312.

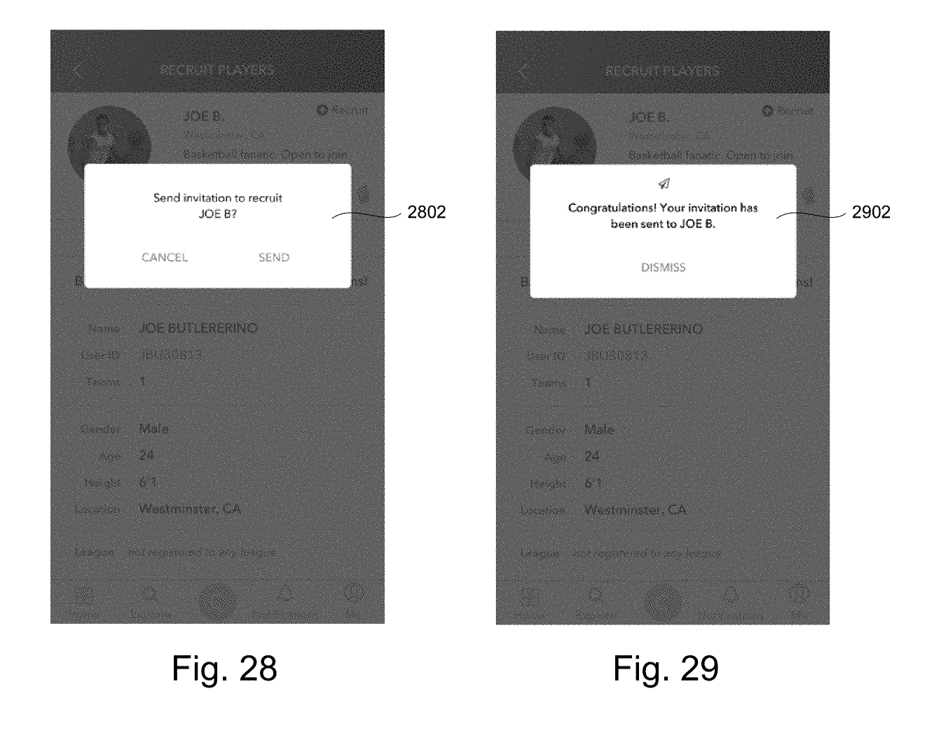

Referring now to FIG. 28, therein is shown a graphical depiction of the team formation system 100 of FIG. 1 in a display recruiting members selected member request confirmation step. The display recruiting members selected member request confirmation step can be displayed based on the team formation system 100 detecting the selection of the recruit member option 2708 as a member recruit request.

The team formation system 100 can displaying a request to confirm 2802 that the member recruit request should be sent prior to sending the member recruit request. The team formation system 100 can send the member recruit request to the selected member 2604 including sending the team profile 400 of FIG. 4 to the selected member 2604 of FIG. 26.

Referring now to FIG. 29, therein is shown a graphical depiction of the team formation system 100 of FIG. 1 in a display recruiting members selected member response step. The display recruiting members selected member response step can display a confirmation 2902 that the member recruit request has been sent. The team formation system 100 can further detect a member recruit response and can display the member recruit response of the selected member 2604 of FIG. 26 to the recruiting member.

Referring now to FIG. 30, therein is shown a control flow for the team formation system 100 of FIG. 1. The team formation system 100 is depicted having members 3002 interfacing with the team formation system 100 through the distributed computing system 102 including the user devices 108 of FIG. 1.

The team formation system 100 can include a platform front-end 3002 providing platform features 3006 including the join teams tool 202, the create teams tool 204, and the recruit member tool 206. The join teams tool 202, the create teams tool 204, and the recruit member tool 206 can query both the member table 3020 and the team table 3022 residing in the database 3030. The platform front-end 3002 and the database 3030 can interface with a platform back end 3032.

Thus, it has been discovered that the team formation system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the team formation system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

More particularly, it has been discovered that creating a team profile including team profile information; storing the team profile information on a team table in a database; creating a member profile, the member profile including personal information and athletic information; storing the member profile on a member table in the database; searching the member table based on member search criteria; displaying a potential member based on the potential member having the member profile matching the member search criteria, and displaying the potential member includes displaying a member location, a member name, a member age, a member height, a member identification number, and a member image; detecting the selection of the potential member as a selected member; displaying the selected member including the member location, the member name, a member statement, the member image, a member teams tab, a member schedule tab, and a recruit member option; detecting the selection of the recruit member option as a member recruit request; sending the member recruit request to the selected member; detecting a member recruit response; displaying the member recruit response; searching the team table based on team search criteria; displaying a potential team based on the potential team having the team profile information matching the team search criteria, and displaying the potential team includes displaying a team location, a team name, a sport type, a team identification number, a number of team members, a team description, and a team image; detecting a team selection of the potential team as a selected team; displaying the selected team including the team location, the team name, the sport type, the team description, the team image, a team roster, a team schedule, and a join team option; detecting the selection of the join team option as a join team request by a member; sending the join team request to a team captain; detecting a join team response; and displaying the join team response produce non-abstract improvements because this data-structure and this set of rules reduces complexity in team formation and data usage thus reducing overall computing requirements in terms of processing overhead, data transmission, storage overhead and power consumption. Yet further, this data-structure and this set of rules enables computing systems to accomplish team formation by implementing computing processes, something humans did not previously employ.

What is claimed is:

1. A method of team formation comprising:
creating a team profile including team profile information;
storing the team profile information on a team table in a database;
creating a member profile, the member profile including personal information and athletic information;
storing the member profile on a member table in the database;
searching the member table based on member search criteria;
displaying a potential member based on the potential member having the member profile matching the member search criteria, and displaying the potential member includes displaying a member location, a member name, a member age, a member height, a member identification number, and a member image;
detecting the selection of the potential member as a selected member;
displaying the selected member including the member location, the member name, a member statement, the member image, a member teams tab, a member schedule tab, and a recruit member option;
detecting the selection of the recruit member option as a member recruit request;
sending the member recruit request to the selected member;
detecting a member recruit response;
displaying the member recruit response;
searching the team table based on team search criteria;
displaying a potential team based on the potential team having the team profile information matching the team search criteria, and displaying the potential team includes displaying a team location, a team name, a sport type, a team identification number, a number of team members, a team description, and a team image;
detecting a team selection of the potential team as a selected team;
displaying the selected team including the team location, the team name, the sport type, the team description, the team image, a team roster, a team schedule, and a join team option;
detecting the selection of the join team option as a join team request by a member;
sending the join team request to a team captain;
detecting a join team response; and
displaying the join team response.

2. The method of claim 1 wherein creating the member profile includes creating the member profile with personal information and athletic information, the personal information including member name, member location, member image, and member statement, the member statement being a character string, the athletic information including member gender, member age, member height, member positions played, member level of play, member statistics, and member achievements.

3. The method of claim 1 wherein creating the team profile includes creating the team profile having the team profile information including the team name, a team type, the sport type, a play level, a required age, and the team location, the team profile includes the team type displayed as a men's selection, a women's selection, and a co-ed's selection, the team location includes a practice location, a home game location, and an away game location, the sport type includes icons and descriptors for member selection, the team profile includes the play level as a recreational selection, an academic selection, and a professional selection.

4. The method of claim 1 wherein searching the member table based on member search criteria includes searching based on a member's team, member's age, member's height, and member's location, searching the member table includes displaying a team as a selection in a list, searching the member table includes displaying a selection for a youngest age and an oldest age, and searching the member table includes displaying a selection for a shortest height and a tallest height.

5. The method of claim 1 wherein displaying the selected member including the member teams tab includes displaying a team of the selected member, displaying a schedule of the selected member.

6. The method of claim 1 wherein sending the member recruit request to the selected member includes sending the team profile to the selected member, displaying a request to confirm that the member recruit request should be sent, and displaying a confirmation that the member recruit request has been sent.

7. The method of claim 1 wherein searching the team table based on team search criteria includes searching based on the team type, the sport type, the play level, and the team location, displaying the team type as men's, women's, and co-ed's for member selection, displaying the sport type including icons and descriptors for member selection, and displaying the play level including recreational, academic, and professional for member selection.

8. The method of claim 1 wherein displaying the selected team including the team roster includes displaying a team member profile, the team member profile including a first name, a last name, an age, a height, a location, an image, a member identification number, and a team captain icon, and displaying the team schedule including the time, location, and opposing team for a future game.

9. The method of claim 1 wherein sending the join team request to the team captain includes sending the join team request along with the personal information and athletic information of the member profile of the member selecting the join team request.

10. A computer readable medium in useful association with a processor including instructions configured to:
create a team profile including team profile information;
store the team profile information on a team table in a database;
create a member profile, the member profile including personal information and athletic information;
store the member profile on a member table in the database;
search the member table based on member search criteria;
display a potential member based on the potential member having the member profile matching the member search criteria, and displaying the potential member includes displaying a member location, a member name, a member age, a member height, a member identification number, and a member image;
detect the selection of the potential member as a selected member;
display the selected member including the member location, the member name, a member statement, the member image, a member teams tab, a member schedule tab, and a recruit member option;
detect the selection of the recruit member option as a member recruit request;
send the member recruit request to the selected member;
detect a member recruit response;
display the member recruit response;
search the team table based on team search criteria;
display a potential team based on the potential team having the team profile information matching the team search criteria, and displaying the potential team includes displaying a team location, a team name, a sport type, a team identification number, a number of team members, a team description, and a team image;
detect a team selection of the potential team as a selected team;
display the selected team including the team location, the team name, the sport type, the team description, the team image, a team roster, a team schedule, and a join team option;
detect the selection of the join team option as a join team request by a member;
send the join team request to a team captain;
detect a join team response; and
displaying the join team response.

11. The computer readable medium of claim 10 wherein the instructions configured to create the member profile includes instructions configured to create the member profile with personal information and athletic information, the personal information including member name, member location, member image, and member statement, the member statement being a character string, and the athletic information including member gender, member age, member height, member positions played, member level of play, member statistics, and member achievements.

12. The computer readable medium of claim 10 wherein the instructions configured to create the team profile includes instructions configured to create the team profile having the team profile information including the team name, the team type, the sport type, the play level, a required age, and the team location, the team profile, the team type displayed as a men's selection, a women's selection, and a co-ed's selection, the team location including a practice location, a home game location, and an away game location, and the sport type includes icons and descriptors for member selection, the team profile includes the play level as a recreational selection, an academic selection, and a professional selection.

13. The computer readable medium of claim 10 wherein the instructions configured to search the member table based on member search criteria includes instructions configured to search based on a member's team, member's age, member's height, and member's location, including a team as a selection displayed in a list, a selection for a youngest age and an oldest age, and a selection for a shortest height and a tallest height.

14. The computer readable medium of claim 10 wherein the instructions configured to display the selected member including the member teams tab includes instructions configured to display a team of the selected member and display a schedule of the selected member.

15. The computer readable medium of claim 10 wherein the instructions configured to send the member recruit request to the selected member includes instructions configured to send the team profile to the selected member, display a request to confirm that the member recruit request should be sent, and display a confirmation that the member recruit request has been sent.

16. The computer readable medium of claim 10 wherein the instructions configured to search the team table based on team search criteria includes instructions configured to search based on the team type, the sport type, the play level, and the team location, display the team type as men's, women's, and co-ed's for member selection, display the sport type including icons and descriptors for member selection, and display the play level including recreational, academic, and professional for member selection.

17. The computer readable medium of claim 10 wherein the instructions configured to display the selected team including the team roster includes instructions configured to display a team member profile, the team member profile including a first name, a last name, an age, a height, a location, an image, a member identification number, and a team captain icon, and display the team schedule including the time, location, and opposing team for a future game.

18. The computer readable medium of claim 10 wherein the instructions configured to send the join team request to the team captain includes instructions configured to send the join team request along with the personal information and athletic information of the member profile of the member selecting the join team request.

19. A team formation system comprising:
a processor configured to create a team profile including team profile information, store the team profile information on a team table in a database, create a member profile, the member profile including personal information and athletic information, store the member profile on a member table in the database, search the member table based on member search criteria, display a potential member based on the potential member having the member profile matching the member search criteria, and displaying the potential member includes displaying a member location, a member name, a member age, a member height, a member identification number, and a member image, detect the selection of the potential member as a selected member, detect the selection of a recruit member option as a member recruit request, send the member recruit request to the selected member, detecting a member recruit response, searching the team table based on team search criteria, detect a team selection of a potential team as a selected team, detect the selection of a join team option as a join team request by a member, send the join team request to a team captain, and detect a join team response; and
a user device having a display configured to display the selected member including the member location, the member name, a member statement, the member image, a member teams tab, a member schedule tab, and the recruit member option, display the member recruit response, display the potential team based on the potential team having the team profile information matching the team search criteria, and displaying the potential team includes displaying a team location, a team name, a sport type, a team identification number, a number of team members, a team description, and a team image, display the selected team including the team location, the team name, the sport type, the team description, the team image, a team roster, a team schedule, and the join team option, and display the join team response.

20. The system of claim 19 further comprising a server configured to store the team table, the member table, the member table and the team table being a part of the database.
